(19) United States
(12) Patent Application Publication
(10) Pub. No.: US 2004/0123525 A1
(43) Pub. Date: Jul. 1, 2004

(54) Door control device

(75) Inventors: Shintaro Suzuki, Kasugai-shi (JP); Tomoaki Imaizumi, Aichi-ken (JP); Eiji Itami, Chiryu-shi (JP); Katsuhisa Yamada, Toyota-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA

(21) Appl. No.: 10/680,182

(22) Filed: Oct. 8, 2003

(30) Foreign Application Priority Data
Oct. 8, 2002 (JP) 2002-294459

(51) Int. Cl. E05F 11/00

(52) U.S. Cl. 49/360; 49/324

(57) ABSTRACT

A door control device includes a door, a manual operation detecting device, a speed detecting device, a driving device, a clutch disposed between the driving device and the door for allowing or prohibiting a driving force to be transmitted from the driving device to the door, and a control device for controlling the clutch based on an operation state of the door detected by the manual operation detecting device and the door speed detected by the speed detecting device. The control device controls to disengage the clutch when the manual operation is detected by the manual operation detecting device, and engage the clutch when the door speed is determined to be equal to or greater than a first value and then becomes equal to or smaller than a second value, which is smaller than the first value.

This application is based on and claims priority under 35 U.S.C. § 119 with respect to Japanese Application No. 2002-294459 flied on Oct. 8, 2002, the entire content of which is incorporated herein by reference.

### FIELD OF THE INVENTION

This invention generally relates to a door control device for electrically opening or closing a door such as a sliding door and a back door relative to a door opening of a vehicle body. More particularly, the present invention pertains to a door control device which switches an operation mode of the door between an electric operation mode and a manual operation mode by means of a clutch.

### BACKGROUND OF THE INVENTION

A known door control device is disclosed in Japanese Patent Laid-Open Publication No. 2002-195304. The disclosed door control device electrically drives to open or close a door such as a sliding door provided at a side portion of a vehicle relative to an opening of a vehicle body for improving performance in case that a passenger gets In or out of the vehicle. The door control device includes a clutch provided between a motor and the sliding door for allowing or prohibiting a driving force to be transmitted from the motor to the door.

The clutch connects a power transmission system from the motor to the sliding door when the sliding door is electrically driven so that the sliding door is moved by the driving force of the motor. When the sliding door is intended to be manually operated, the power transmission system is disconnected due to disengagement of the clutch disposed between the motor and the sliding door, thereby enabling the manual operation of the sliding door.

According to the above door control device, the sliding door can be held in a full-open position by a secure engagement of a hook provided at the sliding door side with a striker provided at the vehicle body side caused by an engagement between a ratchet and the hook provided at the sliding door side. The sliding door can be also held in a predetermined halfway position by a stopper provided at a middle portion of sliding way of the sliding door.

In case that the sliding door is manually opened under the condition that the vehicle is parked or stopped on a sloping road such as an uphill and a downhill, the sliding door may be moved to a downward side due to a weight thereof. The sliding door cannot be held in any position defined by the manual operation and thus the performance in case that the passenger gets in or out of the vehicle is not high.

Thus, a need exists for a door control device that can hold a sliding door in any position defined by the manual operation when the door is manually operated.

### SUMMARY OF THE INVENTION

According to an aspect of the present invention, a door control device includes a door for opening or closing a door opening of a vehicle body, a manual operation detecting means provided at the door for detecting the manual operation of the door, a speed detecting means for detecting a door speed when the door is opened or closed, and a driving means for driving the door. The door control device further includes a clutch disposed between the driving means and the door for allowing or prohibiting a driving force to be transmitted from the driving means to the door, and a control means for controlling the clutch based on an operation state of the door detected by the manual operation detecting means and the door speed detected by the speed detecting means. The control means controls to disengage the clutch when the manual operation is detected by the manual operation detecting means, and engage the clutch when the door speed is determined to be equal to or greater than a first value and then becomes equal to or smaller than a second value, which is smaller than the first value.

### BRIEF DESCRIPTION OF THE DRAWING FIGURES

The foregoing and additional features and characteristics of the present invention will become more apparent from the following detailed description considered with reference to the accompanying drawing FIGUREs in which like reference numerals designate like elements and wherein:

FIG. 1 is a block view of a whole structure of a door control device according to an embodiment of the present invention; and

FIG. 2 is a flowchart showing a procedure of a CPU shown in FIG. 1.

### DETAILED DESCRIPTION OF THE INVENTION

An embodiment of the present invention is explained referring to attached drawings. According to the present embodiment, a door control device 1 is employed in a door such as a sliding door 3 driven to slide relative to a door opening 4 of a vehicle 5.

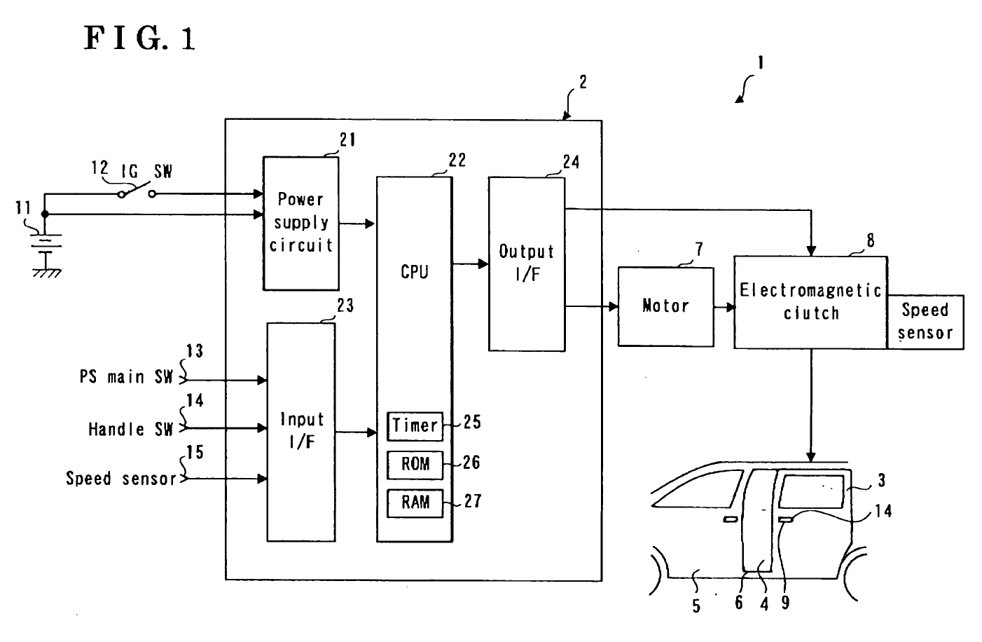

FIG. 1 shows a structure of the door control device 1 of the vehicle 5. The door control device 1 includes the sliding door 3 slidable along a pair of guide rails 6 arranged in the vicinity of an upper edge portion and a lower edge portion respectively of the door opening 4 and extending in a longitudinal direction of the vehicle 5, i.e. a vehicle traveling direction. The door control device 1 also includes a handle switch 14 (manual operation detecting means) provided on a backside of a handle 9, i.e. a side facing the sliding door 3, the handle 9 serving as an operation member provided on the sliding door 3. A signal status of the handle switch 14 is turned to ON status from OFF status when the handle 9 is manually operated. The door control device 1 further Includes a motor 7 (driving means) serving as a driving source for driving the sliding door 3 and a clutch such as an electromagnetic clutch 8 disposed between the motor 7 and the sliding door 3 and allowing or prohibiting the driving force to be transmitted from the motor 7 to the sliding door 3. A wire (not shown) for pulling the sliding door along the guide rails 6 is disposed between the electromagnetic clutch 8 and the sliding door 3. According to the above-mentioned structure, the sliding door 3 is open or closed relative to the door opening 4 by being pulled by the wire when the electromagnetic clutch 8 is engaged. On the other hand, when the electromagnetic clutch 8 is disengaged, the sliding door 3 can be manually operated along the guide rails 6.

The electromagnetic clutch 8 is equipped with a speed sensor 15 (speed detecting means) for detecting a rotational speed of the electromagnetic clutch 8 by a pulse output thereof to detect a moving speed of the sliding door 3 (door speed). The detected door speed is Input to a control unit 2.

The control unit 2 includes a power supply circuit 21 for generating a predetermined voltage (for example, 5V), a CPU 22 for performing a power sliding control, i.e. electrically driving the sliding door 3, an Input Interface circuit (input I/F circuit) 23 for inputting a signal from a sensor, a switch and the like provided at the vehicle 5, and an output interface circuit (output I/F circuit) 24 for amplifying a signal output from the CPU 22 to be converted into a drive signal for the motor 7. The CPU 22 includes a timer 25 for counting an operating time of the sliding door 3, a ROM 26 for storing a control program and a RAM 27 for successively storing a required status for a program process.

The control unit 2 is supplied with a predetermined power supply (for example, battery voltage: 12V) from a battery 11 provided at the vehicle 5. The battery voltage is supplied to the control unit 2 when a vehicle key is inserted into a key cylinder (not shown) and an ignition switch 12 becomes in ON status. Even when the ignition switch is not in ON status, a predetermined power supply (continuous power supply: 12V) is provided to the control unit 2, thereby enabling to operate the control unit 2 without the vehicle key Inserted Into the key cylinder or the ignition switch 12 in ON status.

The power supply provided from the battery 11 is input to the power supply circuit 21 of the control unit 2 where a stabilized power supply (for example, 5V) is generated.

The input I/F circuit 23 of the control unit 2 receives a signal from a power slide main switch (PS main SW) 13 provided adjacent to a driver seat such as a center console and a front panel for initiating a power sliding operation. At the same time, the input I/F circuit 23 receives a signal from the handle switch 14 provided at the handle 9 of the sliding door 3 and a speed signal from the speed sensor 15. The control unit 2 determines the received signals and outputs signals for driving the motor 7 and operating the electromagnetic clutch 8. As a result, the motor 7 is driven and also the electromagnetic clutch 8 is driven to engage or disengage.

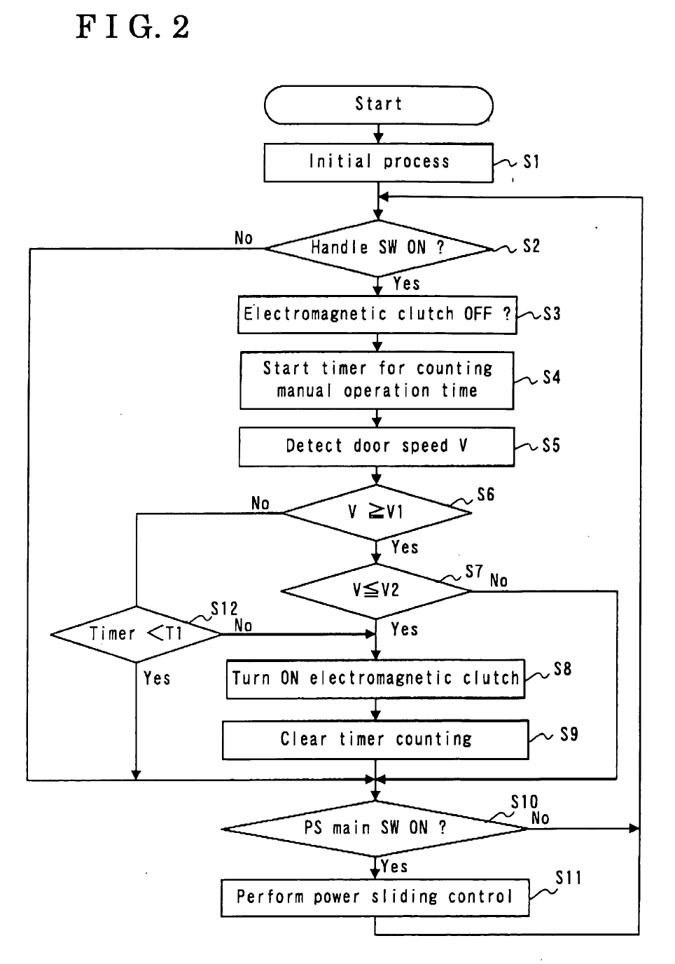

The program process performed by the CPU 22 is explained with reference to a flowchart of FIG. 2. Each step of the program is simply indicated by “S” In the following. The flowchart of FIG. 2 mainly explains the process performed by the CPU 22 in case that the sliding door 3 is manually operated. A known method may be employed for a normal sliding control, i.e. power sliding control, and thus the detailed explanation thereof is omitted.

When the predetermined voltage (for example, 5V) is supplied to the CPU 22 of the control unit 2 from the battery 11, the program of FIG. 2 is initiated. First, an initial process is performed in S1. In the initial process, each status of the ROM 26 and the RAM 27 is checked. At the same time, an initial value required for the program process is stored in the RAM 27. Then, it is determined whether or not the door control device 1 is under any error conditions.

Next in S2, the CPU 22 determines whether or not the handle switch 14 is operated by an operator. When the sliding door 3 is manually operated to open, the status of the handle switch 14 is turned to ON status from OFF status. In addition, when the operator releases the handle 9, the status of the handle switch 14 is again turned to OFF status from ON status. The CPU 22 can thus detect the manually operated handle state.

In case that the sliding door 3 is not manually operated, the program proceeds to S10 with the sliding door 3 being maintained in the present state thereof.

Whereas, when the handle switch 14 is switched to ON status, i.e. the sliding door 3 is manually operated, the power transmission between the motor 7 and the sliding door 3 requires to be disconnected so as to allow the manual operation of the sliding door 3. In S3, thus, the CPU 22 controls the electromagnetic clutch 8 in OFF status, thereby disconnecting a transmission passage of the driving force from the motor 7 to the sliding door 3. When the transmission passage is disconnected, the sliding door 3 can be manually open or closed along the guide rails 6. Then in S4, the CPU 22 starts the timer 25 for counting and monitoring an elapsed time from a start of the manual operation of the sliding door 3.

Next, the CPU 22 detects a door speed V based on a signal from the speed sensor 15 in S5. The signal output from the speed sensor 15 responds to a rotational speed of the electromagnetic clutch 8. That Is, a pulse number of the signal is increased when the rotational speed of the electromagnetic clutch 8 is fast and decreased when the rotational speed of the electromagnetic clutch 8 is slow. The moving speed (door speed) V of the sliding door 3 is detected based on a number of pulses being input within a predetermined time. In S6, the CPU 22 determines whether or not the door speed V is equal to or greater than a predetermined speed V1 (first speed). When the door speed V is equal to or greater than the predetermined speed V1, the program proceeds to S7. On the other hand, when the door speed V is smaller than the predetermined speed V1 (in this case, a third door speed), the program exceeds to S12. According to the present embodiment, the third door speed is equal to the first speed. However, the third door speed can be smaller than the first speed.

In S12, the CPU 22 determines whether or not a state in which the door speed V is smaller than the predetermined speed V1 is continued, i.e. whether or not a predetermined time T1 (for example, several seconds) has elapsed under the condition that the door speed V is smaller than the predetermined speed V1. The program proceeds to S10 without changing a state of the present manual operation of the sliding door 3 when a counted time by the timer 25 for the manual operation is within the predetermined time T1. Meanwhile, when the elapsed time from the initiation of the manual operation of the sliding door 3 exceeds the predetermined time T1, the program proceeds to S8 where the sliding door 3 is forcedly controlled to be maintained in the present position.

Meanwhile, In S7, the CPU 22 determines whether or not the door speed V becomes equal to or smaller than a predetermined speed V2 (second speed), which is regarded to be zero or extremely close to zero (V2>V1), after the door speed V Is determined to be equal to or greater than the predetermined speed V1. When the door speed V is greater than the predetermined speed V2 (i.e. V is specified between V2 and V1), the program proceeds to S10 where the present manual operation of the sliding door 3 is maintained. On the other hand, when the door speed V becomes equal to or smaller than the predetermined speed V2 after the door speed V is determined to b equal to or greater the predetermined speed V1, the CPU 22 concludes that the operator operating the sliding door 3 intends to stop the manual operation of the sliding door 3.

When the manual operation of the sliding door 3 is stopped, then the CPU 22 outputs a signal to the electromagnetic clutch 8 so as to engage the electromagnetic clutch 8 in S8. The power transmission system for transmitting the driving force from the motor 7 to the sliding door 3 is directly connected accordingly. Even when the sliding door 3 is manually operated and then the handle 9 is released under the condition that the vehicle 5 is stopped or parked on a sloping road and the like, the sliding door 3 can be maintained in any position defined by the manual operation without the sliding door 3 moving in an opening direction or closing direction thereof by a weight of the sliding door 3 since the electromagnetic clutch 8 is engaged. That is, the sliding door 3 can be maintained not only in a predetermined position but also in any position defined by the manual operation under the vehicle 5 being stopped or parked on the sloping road and the like. After the CPU 22 controls the electromagnetic clutch 8 in ON status, the CPU 22 clears the counted time of the timer 25 in response to the end state of the manual operation of the sliding door 3 in S9.

The CPU 22 then determines whether or not a power sliding control of the sliding door 3 is required through an operation of the power slide main switch 13 in S10. When the power slide main switch 13 is not operated, the CPU 22 concludes that the operation state of the sliding door 3 is not changed and returns to S2 without performing the power sliding control. The CPU 22 repeats the aforementioned process from S2.

Meanwhile, when the power sliding main switch 13 is operated, a known power sliding control is performed in S11. Then the CPU 22 returns to S2 and repeats the process therefrom through S10.

The present embodiment is employed in the sliding door 3 of the vehicle 5 as mentioned above. However, the embodiment is not limited to the sliding door 3 and may be employed in a back door for opening a rear portion of the vehicle 5. The back door can be maintained in any position defined by the manual operation.

According to the present invention, when the manual operation of the sliding door 3 is detected by a manual operation detection means, the electromagnetic clutch 8 is disengaged by a control means. The sliding door 3 is moved by the manual operation. Then, the control means controls to engage the electromagnetic clutch 8 in response to the door speed V, i.e. when the door speed V becomes equal to or smaller than the second speed V2 after the door speed V is determined to be equal to or greater than the first speed V1. Therefore, the sliding door 3 can be maintained in any position defined by the manual operation, considering the intention of the operator in opening or closing the sliding door 3 by the manual operation.

In this case, when the second speed V2 is substantially zero, the sliding door 3 can be maintained in any position defined by the manual operation by certainly detecting the operation stopped state of the sliding door 3 by the manual operation.

In addition, the control means controls to engage the electromagnetic clutch 8 when a state in which the door speed V Is smaller the third speed V3 has elapsed over the predetermined time T1 after the manual operation of the sliding door is detected. The sliding door 3 can be manually operated until the electromagnetic clutch 8 is engaged after the manual operation is detected. In this case, the sliding door 3 can be surely maintained in any position defined by the manual operation. In addition, the sliding door 3 can be surely stopped in any position defined by the manual operation after the manual operation of the door even when the vehicle Is stopped on the sloping road and the like.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

What is claimed is:

1. A door control device comprising:
A door for opening or closing a door opening of a vehicle body;
a manual operation detecting means provided at the door for detecting the manual operation of the door;
a speed detecting means for detecting a door speed when the door Is opened or closed;
a driving means for driving the door;
a clutch disposed between the driving means and the door for allowing or prohibiting a driving force to be transmitted from the driving means to the door; and
a control means for controlling the clutch based on an operation state of the door detected by the manual operation detecting means and the door speed detected by the speed detecting means, wherein the control means controls to disengage the clutch when the manual operation is detected by the manual operation detecting means, and engage the clutch when the door speed is determined to be equal to or greater than a first value and then becomes equal to or smaller than a second value, which is smaller than the first value.

2. A door control device according to claim 1, wherein the second value is zero.

3. A door control device according to claim 1, wherein the control device controls to engage the clutch when a predetermined time is elapsed after the manual operation is detected under a condition that the door speed is smaller than a third value.

4. A door control device according to claim 3, wherein the third value is equal to or smaller than the first value.

5. A door control device according to claim 4, wherein the manual operation detecting means Includes a handle switch arranged at a door handle provided on the door.

6. A door control device according to claim 5, wherein the speed detecting means includes a speed sensor provided at the clutch.

7. A door control device according to claim 6, wherein the clutch includes an electromagnetic clutch.

8. A door control device according to claim 7, wherein the control means includes a CPU having a timer for counting an operating time of the door, a ROM and a RAM.
